(19) United States
(12) Patent Application Publication
(10) Pub. No.: US 2010/0140849 A1
(43) Pub. Date: Jun. 10, 2010

(54) EXTRUSION-BASED LAYERED DEPOSITION SYSTEMS USING SELECTIVE RADIATION EXPOSURE

(75) Inventors: James W. Comb, Hamel, MN (US); William R. Priedeman, JR., Long Lake, MN (US)

Correspondence Address: WESTMAN CHAMPLIN & KELLY, P.A., SUITE 1400, 900 SECOND AVENUE SOUTH, MINNEAPOLIS, MN, 55402, US

(73) Assignee: STRATASYS, INC., Eden Prairie, MN (US)

(21) Appl. No.: 12/531,237

(22) PCT Filed: Feb. 15, 2008
(86) PCT No.: PCT/US08/02020

§ 371 Date: Feb. 1, 2010

Related U.S. Application Data
(60) Provisional application No. 60/919,395, filed on Mar. 22, 2007.

(51) Int. Cl. B29C 35/08

(52) U.S. Cl. 264/401; 425/174.4

(57) ABSTRACT

A system for building a three-dimensional object based on build data representing the three-dimensional object, the system comprising an extrusion head configured to deposit a radiation-curable material in consecutive layers, where the radiation-curable material of each of the consecutive layers is in a self-supporting state, and a radiation source configured to selectively expose a portion of at least one of the consecutive layers to radiation in accordance with the build data.

### CROSS-REFERENCE TO RELATED APPLICATION(S)

This Application is a 371 National Stage Application of International Application No. PCT/US2008/002020, filed on Feb. 15, 2008, published as International Publication No. WO 2008/118263, and which claims priority to U.S. Provisional Application No. 60/919,395, filed on Mar. 22, 2007, the disclosures of which are incorporated by reference in their entireties.

### BACKGROUND

The present invention relates to the fabrication of three-dimensional (3D) objects using extrusion-based layered manufacturing systems. In particular, the present invention relates to extrusion-based layered manufacturing systems that fabricate 3D objects with the use of selective radiation exposure in accordance with build data representing the 3D objects.

An extrusion-based layered manufacturing system (e.g., fused deposition modeling systems developed by Stratasys, Inc., Eden Prairie, Minn.) is used to build a 3D object from a computer-aided design (CAD) model in a layer-by-layer manner by extruding a flowable build material. The build material is extruded through a nozzle carried by an extrusion head, and is deposited as a sequence of roads on a substrate in an x-y plane. The extruded build material fuses to previously deposited build material, and solidifies upon a drop in temperature. The position of the extrusion head relative to the base is then incremented along a z-axis (perpendicular to the x-y plane), and the process is then repeated to form a 3D object resembling the CAD model.

Movement of the extrusion head with respect to the base is performed under computer control, in accordance with build data that represents the 3D object. The build data is obtained by initially slicing the CAD model of the 3D object into multiple horizontally sliced layers. Then, for each sliced layer, the host computer generates a build path for depositing roads of build material to form the 3D object.

In fabricating 3D objects by depositing layers of build material, supporting layers or structures are typically built underneath overhanging portions or in cavities of objects under construction, which are not supported by the build material itself. A support structure may be built utilizing the same deposition techniques by which the build material is deposited. The host computer generates additional geometry acting as a support structure for the overhanging or free-space segments of the 3D object being formed. Support material is then deposited from a second extrusion tip pursuant to the generated geometry during the build process. The support material adheres to the build material during fabrication, and is removable from the completed 3D object when the build process is complete.

The current extrusion-based layered manufacturing systems provide high-resolution 3D objects with suitable build times and resolution. However, there is an ongoing need to further reduce the required build times, thereby increasing the throughputs and resolution of such systems.

### SUMMARY

The present invention relates to a system for building a three-dimensional object based on build data representing the three-dimensional object. The system includes an extrusion head that deposits a radiation-curable material in consecutive layers at a high deposition rate, where the radiation-curable material of each of the consecutive layers is cooled to a self-supporting state. The system also includes a radiation source that selectively exposes portions of the consecutive layers to radiation at a high resolution in accordance with the build data.

### BRIEF DESCRIPTION OF THE DRAWINGS

FIG. 1 is a front view of an extrusion-based layered manufacturing system for building 3D objects using selective radiation exposure.

FIG. 2 is a side perspective view of an interior portion of a build chamber of the system, which includes a single extrusion head and an array-based exposure head.

FIG. 3A is a schematic illustration of the interior portion of the build chamber, taken as a top view along a z-axis.

FIG. 3B is an alternative schematic illustration of the interior portion of the build chamber, taken as a top view along a z-axis.

FIG. 3C is a front schematic illustration of a model built with the extrusion-based layered manufacturing system, showing a suitable support structure arrangement.

FIG. 4A is an alternative schematic illustration of an alternative interior portion of a build chamber of the extrusion-based layered manufacturing system, which includes an exposure head with multiple LED arrays.

FIG. 4B is an alternative schematic illustration of a second alternative interior portion of a build chamber of the extrusion-based layered manufacturing system, which includes an exposure head oriented at a saber angle.

FIG. 5 is a side perspective view of a third alternative interior portion of a build chamber of the extrusion-based layered manufacturing system, which includes an array of extrusion heads and an array-based exposure head.

FIG. 6 is a side perspective view of a fourth alternative interior portion of a build chamber of the extrusion-based layered manufacturing system, which includes an array of extrusion heads and an exposure source containing a digital-mirror device.

### DETAILED DESCRIPTION

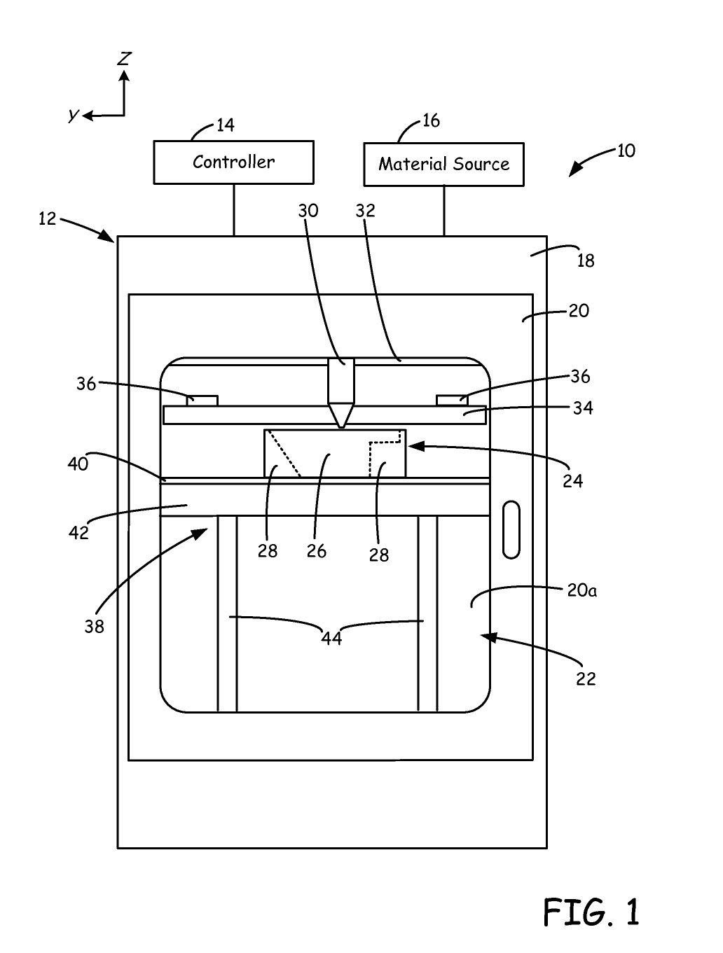

FIG. 1 is a front view of system 10, which is an extrusion-based layered manufacturing system that includes build chamber 12, controller 14, and material source 16. Build chamber 12 includes cabinet 18, chamber door 20, and interior portion 22, where cabinet 18 and chamber door 20 are the external structural components of build chamber 12. While shown in FIG. 1 as having a structure defined by cabinet 18 and chamber door 20, build chamber 12 may alternatively have a variety of different sizes and dimensions (e.g., desktop-sized chambers and room-sized chambers).

Interior portion 22 is a volume defined by cabinet 18 and chamber door 20, visible through window 20a of chamber door 20, and is the location where model 24 is built. As shown, model 24 includes 3D object 26 and support structure 28, each of which are formed from a radiation-curable material. At interior portion 22, build chamber 12 also contains extrusion head 30, guide rail 32, exposure head 34, support rails 36, and substrate assembly 38.

Extrusion head 30 is a single-nozzle extrusion head disposed within cabinet 18. Extrusion head 30 is supported by guide rail 36, which extends along a y-axis, and by additional guide rails (not shown) extending along an x-axis (not shown in FIG. 1) within cabinet 18. This allows extrusion head 30 to move in an x-y plane within cabinet 18 for depositing radiation-curable material in a layer-by-layer manner to form model 24.

Extrusion head 30 desirably deposits the radiation-curable material at a low x-y resolution (i.e., a low resolution in the x-y plane). In general, deposition resolutions are inversely proportional to the movement rates of extrusion heads in the x-y plane. Accordingly, by allowing extrusion head 30 to deposit the radiation-curable material at a low x-y resolution, extrusion heads 30 may move at a high speed in the x-y plane while depositing the radiation-curable material. An example of a suitable low x-y resolution includes about 8,500 micrometers/dot (i.e., about 3 dots-per-inch (dpi)). This correspondingly reduces the time required to deposit the layers of the radiation-curable material, thereby reducing the overall build time.

Exposure head 34 is an ultraviolet (UV)-wavelength radiation source disposed within cabinet 18 for emitting UV light toward model 24. Exposure head 34 is retained by support rails 36 extending along the x-axis within build chamber 12, which allows exposure head 34 to move along the x-axis. Exposure head 34 selectively exposes portions of the deposited layers of model 24 to UV light in accordance with build data representing 3D object 26. The selective exposure cures (i.e., cross-links/polymerizes) the radiation-curable material at the exposed portions of the deposited layers, thereby defining 3D object 26. The uncured portions of the radiation-curable material accordingly remain as support structure 28. Thus, the same radiation-curable material is used to build both 3D object 26 and support structure 28.

As discussed below, exposure head 34 selectively exposes portions of the deposited layers of model 24 to UV light at a high x-y resolution (i.e., a high resolution in the x-y plane). Examples of suitable x-y resolutions for exposure head 34 include resolution sizes of about 170 micrometers/dot or less (i.e., at least about 150 dpi), with particularly suitable resolution sizes including about 85 micrometers/dot or less (i.e., at least about 300 dpi), and with particularly suitable resolution sizes including about 50 micrometers/dot or less (i.e., at least about 500 dpi). Accordingly, the combination of the high-speed deposition and the high x-y resolution UV exposure allows 3D object 26 and support structure 28 to be formed with reduced build times while also retaining good part resolution.

Substrate assembly 38 includes substrate 40, platform 42, and platform rails 44, which are disclosed in Dunn et al., U.S. Publication No. 2005/0173855. Substrate 40 is removably mountable to platform 42, and is the portion of substrate assembly 38 that supports model 24 during a build process. Substrate 40 and platform 42 are supported by platform rails 44, which incrementally move substrate 40 and platform 42 along a z-axis during a build process.

Controller 14 directs the motion and operation of extrusion head 30, exposure head 34, and substrate assembly 38 for building 3D object 26 in a layer-by-layer manner in accordance with build data representing 3D object 26, where the build data is received from a host computer (not shown). The host computer slices a CAD model of 3D object 26 into layers (in the x-y plane) with a slicing algorithm. Build paths are then generated for the sliced layers. The resulting build data is then transmitted to controller 14 for directing extrusion head 30, exposure head 34, and substrate assembly 38 to build 3D object 26 and support structure 28.

Material source 16 is a supply of radiation-curable material connected to extrusion head 30 in a manner that allows the radiation-curable material to be fed from material source 16 to extrusion head 30. For example, for radiation-curable materials provided as filament strands, suitable assemblies for material supply 16 are disclosed in Swanson et al., U.S. Pat. No. 6,923,634 and Comb et al., U.S. Publication No. 2005/0129941. Alternatively, for radiation-curable materials provided as other forms of media (e.g., pellets and resins), material source 16 may be other types of storage and delivery components, such as supply hoppers or vessels.

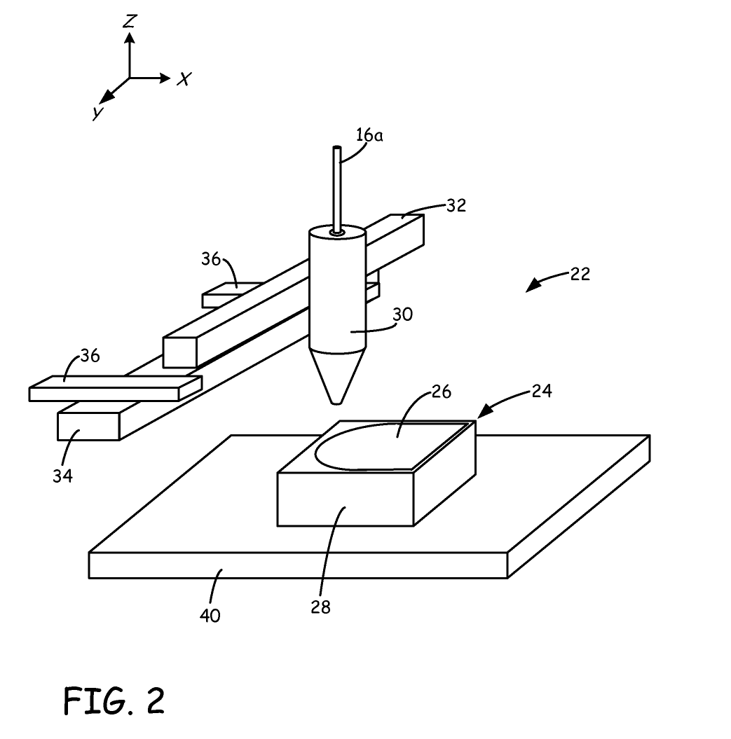

FIG. 2 is a side perspective view of interior portion 22 with cabinet 18 and chamber door 20 of build chamber 12 omitted for clarity. During a build process, extrusion head 30 receives the radiation-curable material from material source 16 (shown above in FIG. 1) through feed line 16a. Extrusion head 30 heats the received radiation-curable material to a flowable state (e.g., a viscosity of about 1,000 poise or less) for deposition. Based on the directions from controller 14 (shown above in FIG. 1), extrusion head 30 moves along the x-y plane to deposit roads of the flowable radiation-curable material onto substrate 40 in a layer-by-layer manner.

Build chamber 12 is configured to operate at a temperature that cools the flowable radiation-curable material to a self-supporting state, even while the radiation-curable material remains non-cured. As used herein, the term “self-supporting state” refers to a state where the radiation-curable material is solidified or is substantially non-flowable (i.e., a viscosity greater than about 20,000 poise with a non-zero elasticity). The particular operating temperatures for build chamber 12 may vary depending on the chemistry of the radiation-curable material used. For example, for a thermoplastic-based, radiation-curable material, build chamber 12 may operate at a temperature below the glass-transition temperature of the given material. As such, even without radiation curing, the layers of deposited radiation-curable material are capable of substantially retaining their shapes and supporting subsequent layers of deposited material. This eliminates the need to laterally support the deposited layers during the build process.

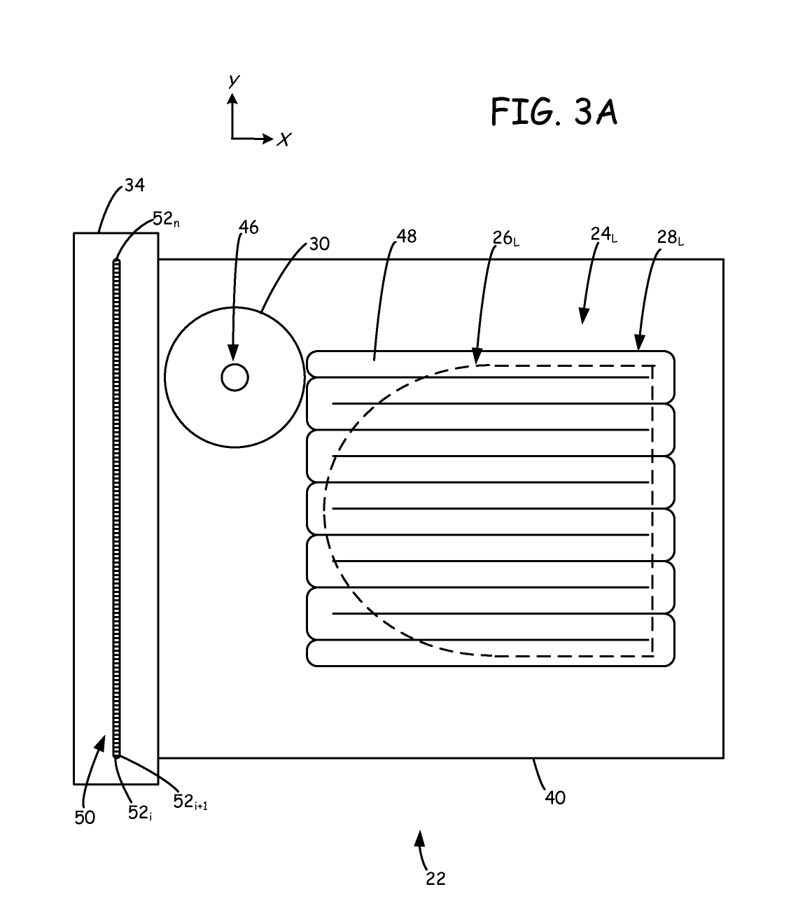

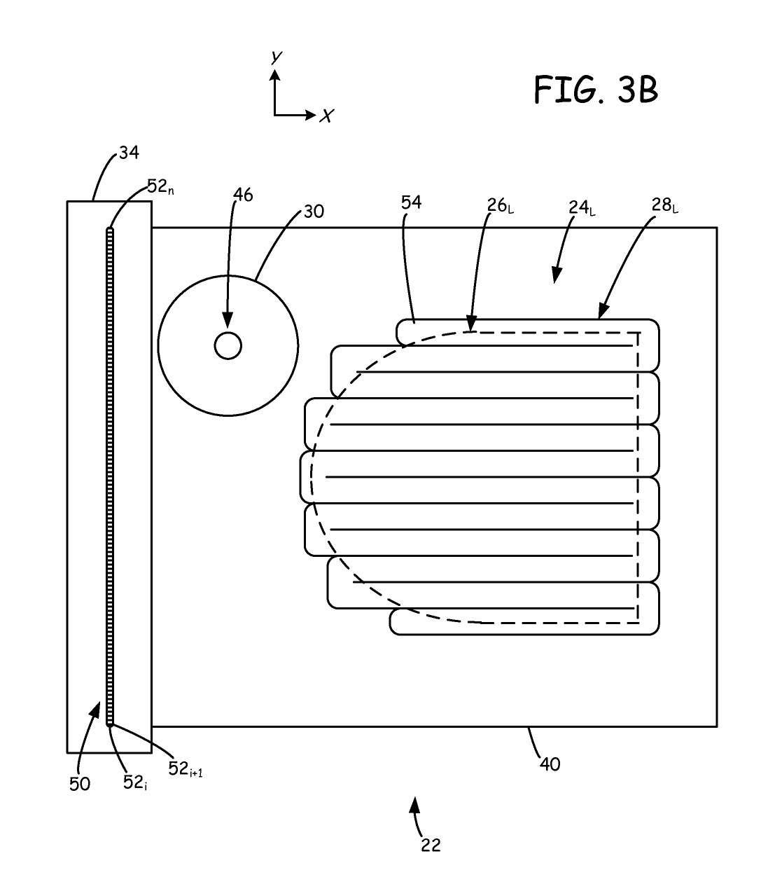

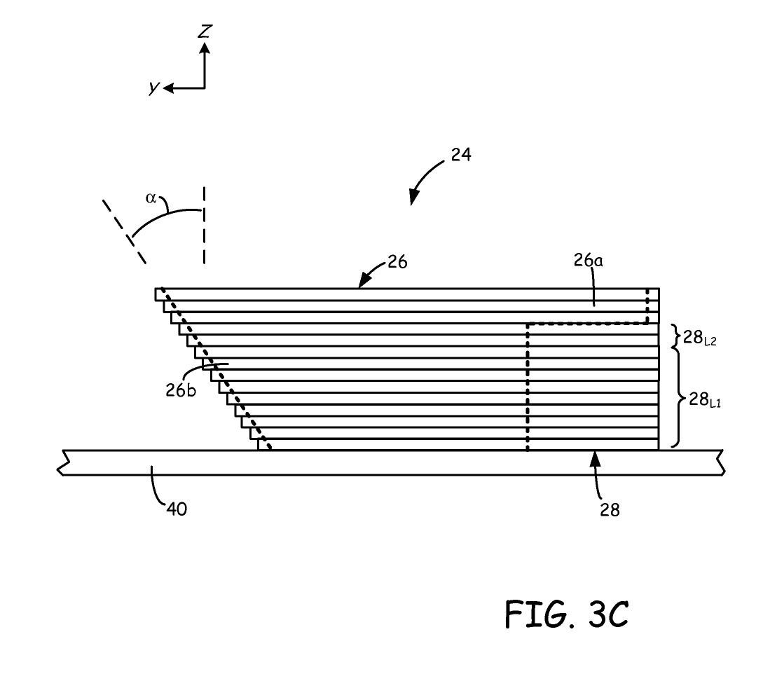

FIG. 3A is a schematic illustration of interior portion 22 taken as a top view along the z-axis, in which guide rail 32 and support rails 36 are omitted for clarity. As shown, extrusion head 30 includes nozzle 46, which is the orifice through which the flowable radiation-curable material is deposited. Because the x-y resolution of 3D object 26 is determined by the radiation exposure pattern of exposure head 34, nozzle 46 may have a large tip diameter for extruding the flowable radiation-curable material at a high rate and a low x-y resolution.

Exposure head 34 includes array 50, which is a linear array of high-resolution, UV light-emitting diodes (LEDs) (referred to as LEDs 52ᵢ, 52ᵢ₊₁, . . . 52ₙ) arranged along the y-axis. Each of LEDs 52ᵢ, 52ᵢ₊₁, . . . 52ₙ are individually controllable to emit UV light in a variety of high-resolution patterns. Examples of suitable UV-radiation sources for exposure head 34 include UV photoexposure products commercially available under the trade designations “P71-1464 CUREBAR” and “P150-3072 PRINTHEAD” from Optotek Ltd., Ottawa, Ontario, Canada.

Alternatively, exposure head 34 may be fabricated from individual LEDs connected to a printed circuit board that communicates with controller 14 (shown above in FIG. 1). This allows arrays and patterns of LEDs to be individually customized for particular curing designs. Examples of suitable individual LEDs include those commercially available under the trade designation “UV-LED” from Nichia Corporation, Tokyo, Japan. The resolution of LEDs 52ᵢ, 52ᵢ₊₁, . . . 52ₙ may also be increased with the use of focusing lenses, which focus the emitted UV light from each LED to a focus point. The focused UV light from each LED is then collimated and refocused at a desired resolution (e.g., using double-ball lenses located in the pathway of the focused UV light).

Exposure head 34 is desirably positioned above model 24 at a working distance along the z-axis (shown above in FIG. 2) that prevents exposure head 34 from interfering with the deposition of model 24, while also allowing the UV light emitted from LEDs 52ᵢ, 52ᵢ₊₁, . . . 52ₙ to focus on the top layer of model 24 at the desired resolution. Examples of suitable working distances between LEDs 52ᵢ, 52ᵢ₊₁, . . . 52ₙ and the top layer of model 24 range from about 0.5 millimeters to about 5 millimeters, and may vary depending on the focus pathways of the emitted UV light.

Model 24 includes layer 24_{L}, which is a layer of radiation-curable material deposited as a series of build roads (e.g., road 48) from nozzle 46. Controller 14 directs extrusion head 30 to deposit the build roads in a raster-pattern, thereby forming layer 24_{L}. As the radiation-curable material is deposited, the reduced temperature of build chamber 12 cools the deposited radiation-curable material, allowing the deposited radiation-curable material to fuse to the previously deposited material in a self-supporting state. After the deposition step, the entire volume of layer 24_{L} includes the radiation-curable material, which is in a non-cured, self-supporting state.

Controller 14 then directs exposure head 34 to move along the x-axis to cure a portion of layer 24_{L} based on the layer data of the sliced CAD model. As used herein, the term “portion”, when referring to a portion of a layers, is intended to include both the singular and plural forms of the term. For example, “curing a portion of layer 24₁” may refer to either a single portion of layer 24_{L} or multiple portions of 24_{L}, and generally depends on the build data.

As exposure head 34 moves along the x-axis, controller 14 individually directs LEDs 52ᵢ, 52ᵢ₊₁, . . . 52ₙ to activate and deactivate in accordance with the layer data. As such, one or more of LEDs 52ᵢ, 52ᵢ₊₁, . . . 52ₙ are activated to emit UV light toward layer 24_{L} in a pattern that corresponds to the particular sliced layer of the CAD model. The high resolution of each of LEDs 52ᵢ, 52ᵢ₊₁, . . . 52ₙ allows UV light to only expose the portion of layer 24_{L} directly below the given LED.

Suitable intensities for LEDs 52ᵢ, 52ᵢ₊₁, . . . 52ₙ range from about 5-50 watts/centimeter², with a movement rate along the x-axis of about 1.5-10.0 centimeters/second. The radiation-curable material at the locations of layer 24_{L} that are exposed to the UV light are cured. This forms portion 26_{L}, which is the part of 3D object 26 that lies in layer 24_{L}. The portion of layer 24_{L} that is not exposed to the UV light (i.e., portion 28_{L}) remains in the non-cured, self-supporting state to function as support structure 28. As such, portion 28_{L} provides underlying support for subsequently deposited layers of radiation-curable material.

In an alternative embodiment, interior portion 22 of build chamber 12 also includes a heat source for heating layer 24_{L}. The rate of cross linking of the radiation-curable material is generally temperature dependant. As such, heating layer 24_{L} prior to exposing layer 24_{L} with the UV light increases the cross-linking rate of the radiation-curable material, thereby allowing lower UV intensities to be used. Suitable heat sources for use in this embodiment include heated contact rollers, infrared-radiation sources, and combinations thereof. For example, after layer 24_{L} is deposited, a heated contact roller may precede exposure head 34 as exposure head 34 moves along the x-axis, thereby allowing the heated contact roller to roll across and heat up layer 24_{L}. The heat source desirably heats layer 24_{L} to a temperature that increases the cross linking rate, while also allowing layer 24_{L} to retain a self-supporting state (e.g., below a glass-transition temperature of the radiation-curable material).

The above-discussed process is repeated such that a portion of at least one layer (preferably a portion of each layer) is exposed to the UV light in accordance with the build data representing 3D object 26. After the layers of model 24 are deposited and cured in accordance with the build data, support structure 28 is then removed from 3D object 26.

Preferably, removal process is performed by either melting or dissolving support structure 28 away from 3D object 26. During the curing steps to define 3D object 26, the cross-linking of the radiation-curable material substantially increases the melting temperature/glass transition temperature of the resulting cross-linked material. For example, for thermoplastic-based, radiation-curable materials, the glass transition temperature of the resulting cross-linked material is substantially greater than the glass transition temperature of the radiation-curable material. Therefore, support structure 28 may be removed by subjecting model 24 to an elevated temperature that is high enough to melt support structure 28, but not high enough to melt 3D object 26.

In one embodiment, model 24 is exposed to the elevated temperature by increasing the temperature within build chamber 12 to a suitable elevated temperature that melts support structure 28. The melted material flows apart from 3D object 26 and may be discarded or recycled for subsequent use. Alternatively, model 24 may be removed from build chamber 12 and placed in a separate oven (not shown) operating at the suitable elevated temperature. The separate oven frees up build chamber 12 during the support removal process.

In addition to increasing melting temperatures/glass transition temperatures, cross-linked materials are also typically insoluble in a variety of solvents due to their cross-linked structures. Therefore, in this embodiment, model 24 is formed by depositing a radiation-curable material that is soluble in a solvent (e.g., water-soluble) while in the uncured state. However, upon curing to form 3D object 26, the resulting cross-linked material is substantially insoluble in the solvent. Support structure 28 is then removed by placing model 24 in a bath containing the solvent, thereby dissolving support structure 28 away from 3D object 26.

Suitable systems and techniques for dissolving support structure 28 are disclosed in Priedeman et al., U.S. Pat. No. 6,790,403. Suitable solvents for dissolving support structure 28 include water aqueous alkaline solutions, aqueous acidic solutions, volatile solvents (e.g., acetone and isopropanol), glycols, and combinations thereof, where the particular solvent will used vary depending on the solubility parameters of the radiation-curable material (e.g., Hildebrand solubility parameters).

In another embodiment, model 24 is placed in a tank operating at a suitable elevated temperature to melt support structure 28 for a sufficient period of time to remove a substantial amount of support structure 28. The tank is then filled with a solvent that dissolves the unmelted portions of support structure 28 away from 3D object 26. This embodiment is beneficial for melting large volumes of support structure 28 at a rapid rate, and then relying on the solvent to dissolve the residual unmelted portions of support structure 28.

After support structure 28 is removed, the resulting 3D object 26 may then undergo post treatment processes, such as bulk-curing, rinsing, vapor smoothing, adhering separate parts, painting, plating, applying labels, machining, assembling parts, metrology, vacuum baking, and combinations thereof. Accordingly, system 10 is beneficial for building quality 3D objects (e.g., 3D object 26) having high resolutions with a high throughput rate.

FIG. 3B is an alternative schematic illustration of interior portion 22 to FIG. 3A. As shown in FIG. 3B, the build path including road 54 more accurately follows the intended area of portion 26_{L} compared to the build path including road 48 (shown above in FIG. 3A). In this embodiment, controller 14 identifies the intended area of portion 26L in the x-y plane, and directs extrusion head 30 to deposit the radiation-curable material at the high speed, low x-y resolution over the intended area. The build path follows the pattern of portion 26_{L} as closely as the low x-y resolution allows, while also ensuring that deposited material covers the entire intended area of portion 26_{L}. This reduces the amount of radiation-curable material being deposited for support structure 28. As a result, the time required to deposit the radiation-curable material, the time required to remove support structure 28, and material costs are correspondingly decreased.

FIG. 3C is a front schematic illustration of model 24 and substrate 40, corresponding to model 24 shown above in FIG. 3B. As shown in FIG. 3C, 3D object 26 (shown with hidden lines) includes overhanging portion 26a, which is supported by support structure 28. In addition to accurately following the intended areas of 3D object 26, the build paths of model 24 may also be modified for support structure requirements, as discussed in Crump et al., U.S. Pat. No. 5,503,785 and Priedeman, U.S. Pat. No. 6,645,412. For example, if layers include overhanging portions that are not supported by previously deposited layers (e.g., overhanging portions 26a and 26b), controller 14 may direct extrusion head 30 to deposit additional roads of radiation-curable material at the appropriate locations to function as support structures (e.g., support structure 28).

Because the radiation-curable material is deposited in a self-supporting state, the deposited layers can bridge small horizontal distances (i.e., in the x-y plane). As such, in one embodiment, the overhanging portion that requires a support structure (e.g., overhanging portion 26a), the support structure (e.g., support structure 28) is formed with sparse, porous layers (i.e., less than 100% density). This is accomplished by depositing the radiation-curable material are the locations of support structure 28 with lower resolutions and/or intermittent depositions, thereby creating pockets in the layers of support structure 28. The subsequent layers of deposited radiation-curable material form bridges over the pockets, thereby forming sparse, porous layers for support structure 28.

Sparse, porous support structures are beneficial because they have higher surface area-to-volume ratios compared to support structures with 100% densities. This correspondingly increases the rates of removal by melting and/or dissolving, thereby reducing the overall build time. In a particularly suitable embodiment, support structure 28 is formed with sparse, porous layers (i.e., layers 28_{L1}) until the deposited layers come within a few layers of overhanging portion 26a (i.e., layers 28_{L2}). The additional roads of radiation-curable material are then deposited at 100% density to ensure that overhanging portion 26a is fully supported.

As further shown in FIG. 3C, 3D object 26 also includes overhanging portion 26b, which is not supported by a support structure. Because the radiation-curable material is deposited in a self-supporting state, the deposited layers can have overhanging portions extending at moderate inclination angles from a vertical axis (e.g., about 45 degrees or less) without requiring support structures. For example, as shown in FIG. 3C, overhanging portion 26b extends from the vertical direction (i.e., the z-axis) at an inclination angle α of about 30 degrees. As a result, the layers of radiation-curable material can be deposited to form overhanging portion 26b without requiring a support structure.

Building 3D object 26 with overhanging portions having moderate inclination angles (e.g., overhanging portion 26b), and building support structure 28 with sparse, porous layers reduces the volume of radiation-curable material required to support 3D object 26. This correspondingly reduces the material costs and deposition times required to build 3D object 26.

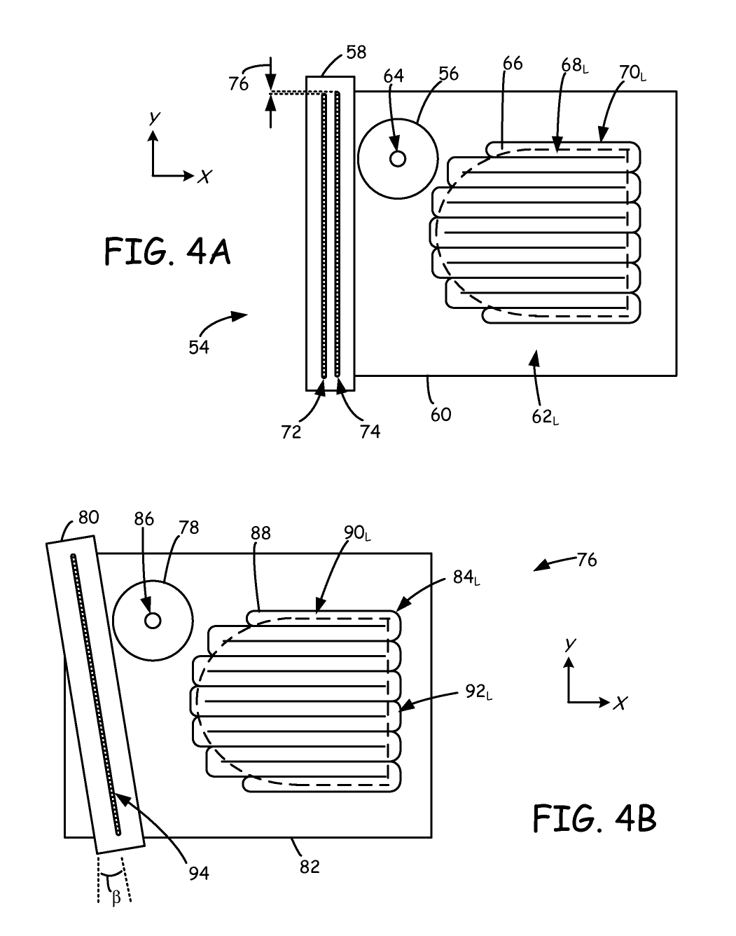

FIG. 4A is a schematic illustration of interior portion 54, which is an alternative to interior portion 22 shown above in FIG. 3B. As shown in FIG. 4A, interior portion 54 includes extrusion head 56, exposure head 58, substrate 60, and layer 62_{L}, where exposure head 58 is used in place of exposure head 34. Extrusion head 56 includes nozzle 64, and operates in the same manner as discussed above for extrusion head 30. Substrate 60 corresponds to substrate 40, shown above in FIGS. 1-3C, and operates in the same manner.

Layer 62_{L} is an alternative layer of model 24 (not shown in FIG. 4A), which is built with extrusion head 56 and exposure head 58. Layer 62_{L} is also a layer of radiation-curable material, and is deposited as a series of build roads (e.g., road 66) from nozzle 64. Layer 62_{L} includes portion 68_{L} and 70_{L}, which are respectively the parts of 3D object 26 and support structure 28 that lie in layer 62_{L}.

Exposure head 58 includes arrays 72 and 74, each of which are linear UV LED arrays that operate in the same manner as discussed above for array 50. As such, arrays 72 and 74 selectively expose a portion of layer 62_{L}, thereby curing the radiation-curable material at portion 68_{L}. Arrays 72 and 74 are arranged in a parallel orientation, in which array 72 is offset from array 74 along the y-axis by a distance 76 to further increase the x-y resolution.

Suitable distances for offset distance 76 include about one-half of the x-y resolutions of arrays 72 and 74. At this offset distance, the LEDs of array 72 are offset along the y-axis from array 74 by one-half of the LED size. This effectively doubles the x-y resolution of exposure head 58 relative to exposure head 34 (shown above), providing a higher x-y resolution for portion 68_{L} compared to portion 26_{L} (shown above in FIGS. 3A and 3B). In alternative embodiments, exposure head 134 may include more than two LED arrays (e.g., from 2-10 arrays) to modify the x-y resolution as necessary.

FIG. 4B is a schematic illustration of interior portion 76, which is another alternative to interior portion 22 shown above in FIG. 3B. As shown in FIG. 4B, interior portion 76 includes extrusion head 78, exposure head 80, substrate 82, and layer 84_{L}, where exposure head 80 is used in place of exposure head 34. Extrusion head 78 includes nozzle 86, and operates in the same manner as discussed above for extrusion heads 30 and 64. Substrate 82 corresponds to substrates 40 and 60, shown above in FIGS. 1-4A, and operates in the same manner.

Layer 84_{L} is another alternative layer of model 24 (not shown in FIG. 4B), which is built with extrusion head 78 and exposure head 80. Layer 84_{L} is also a layer of radiation-curable material, and is deposited as a series of build roads (e.g., road 88) from nozzle 86. Layer 84_{L} includes portion 90_{L} and 92_{L}, which are respectively the parts of 3D object 26 and support structure 28 that lie in layer 84_{L}.

Exposure head 80 includes array 94, which is a linear UV LED arrays that operates in the same manner as discussed above for array 50. As such, array 94 selectively exposes a portion of layer 84_{L}, thereby curing the radiation-curable material at portion 90_{L}. As shown, exposure head 80 is disposed at saber angle β relative to the y-axis to further increase the x-y resolution. Suitable angles for saber angle β range from about 0.1 degree to about 45 degrees. This increases the x-y resolution of exposure head 80 relative to exposure head 34 (shown above), providing a higher x-y resolution for portion 90_{L} compared to portion 26_{L} (shown above in FIGS. 3A and 3B). The saber angle embodiment shown in FIG. 4B may also be combined with the multiple array embodiment shown above in FIG. 4A to even further increase the x-y resolution.

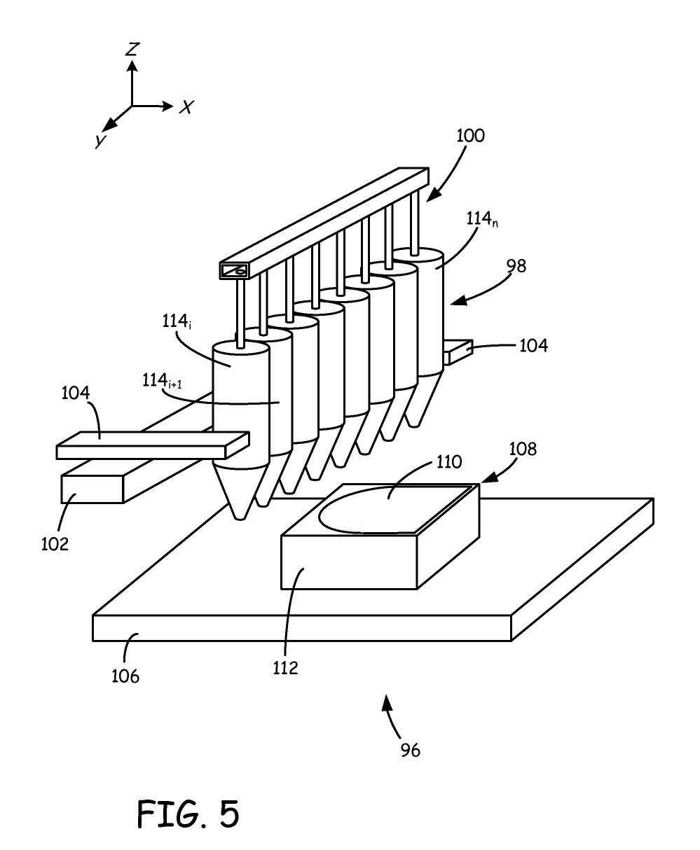

FIG. 5 is a side perspective view of interior portion 96, which is another alternative to interior portion 22, shown above in FIG. 2. As shown in FIG. 5, interior portion 96 includes extrusion array 98, feed line 100, exposure head 102, support rails 104, substrate 106, and model 108, where extrusion array 98 is used in place of extrusion head 30 (shown above in FIG. 2).

Exposure head 102 and support rails 104 operate in the same manner as discussed above for exposure head 34 and support rails 36, and may alternatively include the embodiments shown above in FIGS. 4A and 4B. Substrate 106 corresponds to substrate 40, shown above in FIG. 2, and operates in the same manner. Model 108 is an alternative model to model 24 (shown above in FIG. 2), and includes 3D object 110 and support structure 112, each of which are formed from a radiation-curable material.

Extrusion array 98 is a linear array of extrusion heads (referred to herein as extrusion heads 114ᵢ, 114ᵢ₊₁, . . . 114ₙ) extending along the y-axis. The number of extrusion heads may vary depending on the size of interior portion 96 and the desired x-y resolution. Examples of suitable numbers for extrusion array 98 range from 2-30 extrusion heads. Each of extrusion heads 114ᵢ, 114ᵢ₊₁, . . . 114ₙ is a single-nozzle extrusion head that functions in the same manner as extrusion head 30. Extrusion heads 114ᵢ, 114ᵢ₊₁, . . . 114ₙ are connected to material supply 16 (shown above in FIG. 1) via supply line 100 for depositing radiation-curable material in a layer-by-layer manner.

Extrusion array 98 is retained by support rails 104 of exposure head 102, and does not require separate guide rails. During a build process, controller 14 (shown above in FIG. 1) directs extrusion array 98 and exposure head 102 to move together along the x-axis. While moving, controller 14 directs one or more of extrusion heads 114ᵢ, 114ᵢ₊₁, . . . 114ₙ to individually deposit the radiation-curable material in parallel roads at the low x-y resolution to form a layer of model 108. As extrusion heads 114ᵢ, 114ᵢ₊₁, . . . 114ₙ deposit the radiation-curable material, exposure head 102 selectively exposes portions of the given layer to UV light in accordance with the build data. This arrangement is beneficial because extrusion array 98 is not required to move back-and-forth in a raster pattern, and allows the deposition and selective curing to take place in a single pass. This also reduces the time required to build 3D object 110 and support structure 112.

In alternative embodiments, multiple parallel extrusion arrays 98 and saber angles embodiments may be used in the same manner as shown above for exposure heads 58 and 80 in FIGS. 4A and 4B. This increases the x-y resolution for depositing the radiation-curable material. Additionally, extrusion array 98 may be retained by guide rails (not shown) separate from exposure head 102, and may move in a raster pattern as necessary to attain a desired x-y resolution. In other embodiments, extrusion array 98 may be replaced with non-selective extrusion heads, such as slit extruders, swiper blades, ironed sheets, and cut tapes.

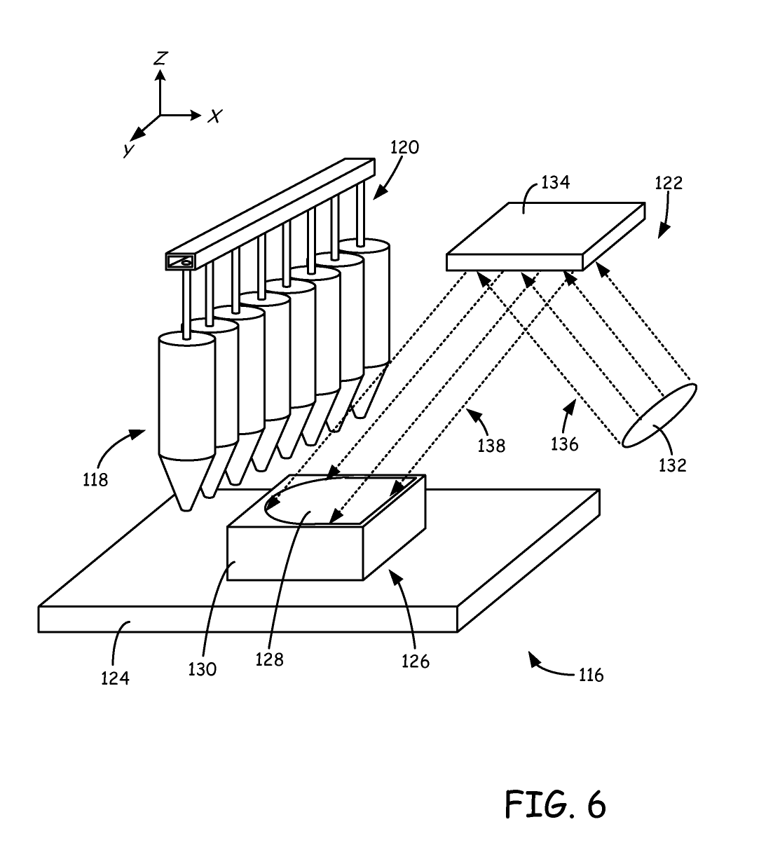

FIG. 6 is a side perspective view of interior portion 116, which is an alternative to interior portion 96, shown above in FIG. 5. As shown in FIG. 6, interior portion 116 includes extrusion array 118, feed line 120, exposure source 122, substrate 124, and model 126, where exposure source 122 is used in place of exposure head 102 (shown above in FIG. 5).

Extrusion array 118 and substrate 124 correspond to extrusion array 98 and substrate 106, shown above in FIG. 5, and operate in the same manner. Alternatively, a single extrusion head (e.g., extrusion head 30) may be used in place of extrusion array 118. Model 126 is an alternative model to models 24 and 108 (shown above in FIGS. 2 and 5), and includes 3D object 128 and support structure 130, each of which are formed from a radiation-curable material.

Exposure source 122 includes UV light source 132 and digital-mirror device 134, where UV light source 132 is a source of UV-wavelength radiation that emits UV light toward digital-minor device 134. Digital-minor device 134 is a light processing mirror that contains a grid of microscopic minor cells, each of which are selectively activated by controller 14 (shown above in FIG. 1) in accordance with the build data of 3D object 128. This allows digital-minor device 134 to selectively reflect the UV light toward substrate 124 with a high x-y resolution. Suitable x-y resolutions for exposure source 122 include those discussed above for exposure head 34. Examples of suitable commercially available digital-mirror devices include those under the trade designation “DIGITAL LIGHT PROCESSING” minors from Texas Instruments Inc., Plano Tex.

After extrusion array 118 deposits radiation-curable material to form a layer of model 126, controller 14 directs digital-mirror device 134 to activate appropriate the minor cells to provide a sliced layer pattern of 3D object 128. UV light source 132 then emits UV light toward digital-mirror device 134 (as represented by arrows 136). Digital-mirror device 134 then reflects only the UV light rays that intersect the activated mirror cells toward substrate 124 (as represented by arrows 138). The reflected UV light rays then cure the radiation-curable material in the same manner as discussed above for exposure head 34. The exposure time and intensity varies depending on the chemistry of the radiation-curable material. These deposition and curing steps are then repeated for the remaining layers of model 126 until 3D object 128 is complete. Support structure 130 is then removed using the above-discussed techniques.

While digital-minor device 134 is shown as a static digital-light processing minor, raster digital-light processing minors, gimbal minor vector lasers, spinning mirror raster lasers, and UV-light shutter arrays may alternatively be used. Furthermore, digital-minor device 134 may also be replaced with a reflective or transmissive liquid crystal display (LCD) panel, which includes an LCD imager and a polarizing beam splitter to direct UV light rays corresponding to a generated sliced layer of 3D object 128 generally in the same manner as with digital-minor device 134.

The radiation-curable material used with the present invention includes one or more polymerizable precursors and one or more photoinitiators. Examples of suitable polymerizable precursors include any material that includes one or more radiation-curable groups, and is capable having a flowable state and a self-supporting state. Such materials include polymerizable monomers, oligomers, macromonomers, polymers, and combinations thereof.

The term “radiation curable” refers to a functionality that is directly or indirectly pendant from the backbone (e.g., side-pendant groups and chain-ending groups) and that reacts (i.e., cross-links) upon exposure to a suitable source of curing energy. While the above-discussed radiation sources (e.g., exposure head 34) are described as UV light sources, alternative actinic-radiation types may also be used to cure the radiation-curable material. Examples of suitable actinic-radiation types include radiation having wavelengths ranging from gamma-rays to UV wavelengths (e.g., gamma, x-ray, and UV), electron beam radiation, and combinations thereof.

Suitable radiation-curable groups for the polymerizable precursor include epoxy groups, (meth)acrylate groups (acryl and methacryl groups), olefinic carbon-carbon double bonds, allyloxy groups, alpha-methyl styrene groups, (meth)acrylamide groups, cyanate ester groups, vinyl ethers groups, and combinations thereof. The polymerizable precursor may be monofunctional or multifunctional (e.g., di-, tri-, and tetra-) in terms of radiation-curable moieties.

Examples of suitable oligomers for the polymerizable precursor include anhydride and carboxylic acid-containing aromatic acid acrylate/methacrylate half ester blends commercially available under the trade designation “SARBOX” from Sartomer Co., Exton, Pa. Such oligomers have high viscosities that allow them to attain a self-supporting state when cooled (e.g., at room temperature or lower). Examples of suitable polymers for the polymerizable precursor include thermoplastic-based, radiation-curable materials, such as functionalized polymers of acrylonitrile-butadiene-styrene (ABS), polycarbonate, polyphenylsulfone, polysulfone, nylon, polystyrene, amorphous polyamide, polyester, polyphenylene ether, polyurethane, polyetheretherketone, and combinations thereof. Additional examples of suitable polymers for the polymerizable precursor include UV-curable hot melt adhesives commercially available from Henkel KgaA, Düsseldorf, Germany; and UV-curable coatings and adhesives commercially available from Rad-Cure Corporation, Fairfield, N.J.

In addition to the polymerizable precursor, the radiation-curable material may also include one or more non-curable materials to modify rheological and strength properties. Suitable non-curable materials include non-curable polyurethanes, acrylic material, polyesters, polyimides, polyamides, epoxies, polystyrenes, silicone containing materials, fluorinated materials, and combinations thereof.

The type of photoinitiator used in the radiation-curable material depends on the polymerizable precursor used and on the wavelength of the radiation used to cure the polymerizable precursor. Examples of suitable free-radical-generating photoinitiators include benzoins (e.g., benzoin alkyl ethers), acetophenones (e.g., dialkoxyacetophenones, dichloroacetophenones, and trichloroacetophenones), benzils (e.g., benzil ketals, quinones, and O-acylated-α-oximinoketones). Examples of suitable cationic-generating photoinitiators include onium salts, diaryliodonium salts of sulfonic acids, triarylsulfonium salts of sulfonic acids, diaryliodonium salts of boronic acids, and triarylsulfonium salts of boronic acids.

Suitable commercially available photoinitiators also include those sold under the trade designations “IRGACURE” and “DAROCUR” from Ciba Specialty Chemicals, Tarrytown, N.Y. Suitable concentrations of the photoinitiator in the radiation-curable material range from about 1% by weight to about 10% by weight, with particularly suitable concentrations ranging from about 2% by weight to about 5% by weight, based on the entire weight of the radiation-curable material.

The radiation-curable material may also include additional additives, such as heat stabilizers, UV light stabilizers (e.g., benzophenone-type absorbers), free-radical scavengers (e.g., hindered amine light stabilizer compounds, hydroxylamines, and sterically-hindered phenols), fragrances, dyes, pigments, surfactants, plasticizers, and combinations thereof. Suitable concentrations of the additional additives in the radiation-curable material range from about 0.01% by weight to about 10% by weight, with particularly suitable total concentrations ranging from about 1% by weight to about 5% by weight, based on the entire weight of the radiation-curable material.

Although the present invention has been described with reference to preferred embodiments, workers skilled in the art will recognize that changes may be made in form and detail without departing from the spirit and scope of the invention. For example, the above-discussed embodiments may be combined in a variety of manners to increase x-y resolutions for the deposition and/or selective radiation exposure.

1. A system for building a three-dimensional object based on build data representing the three-dimensional object, the system comprising:
an extrusion head configured to deposit a radiation-curable material in consecutive layers, the deposited radiation-curable material of each of the consecutive layers being in a self-supporting state; and
a radiation source configured to selectively expose a portion of at least one of the consecutive layers to radiation in accordance with the build data.

2. The system of claim 1, wherein the extrusion head is further configured to heat the radiation-curable material to a flowable state for extrusion.

3. The system of claim 1, wherein the extrusion head is a first extrusion head, and the system further comprises at least a second extrusion head, wherein the first extrusion head and the second extrusion head are arranged in a linear array.

4. The system of claim 1, wherein the radiation source comprises an exposure head having at least one array of light-emitting diodes.

5. The system of claim 1, wherein the radiation source comprises a digital-mirror device.

6. The system of claim 1, wherein the radiation source emits the radiation with a resolution of about 50 micrometers/dot or less.

7. The system of claim 1, wherein the radiation-curable material is soluble in a solvent in an uncured state and is substantially insoluble in the solvent in a cured state.

8. The system of claim 1, wherein the radiation-curable material comprises at least one radiation-curable groups selected from the group consisting of epoxy groups, (meth)acrylate groups (acryl and methacryl groups), olefinic carbon-carbon double bonds, allyloxy groups, alpha-methyl styrene groups, (meth)acrylamide groups, cyanate ester groups, vinyl ethers groups, and combinations thereof.

9. A system for building a three-dimensional object with a radiation-curable material based on a CAD model of the three-dimensional object, wherein the CAD model has a plurality of generated sliced layers, the system comprising:
a build chamber configured to operate at a temperature that cools the radiation-curable material to a self-supporting state;
at least one extrusion head configured to deposit the radiation-curable material as at least one layer within the build chamber; and
a radiation source configured to selectively expose a portion of the at least one layer to radiation, wherein the exposed portion corresponds to one of the generated sliced layers.

10. The system of claim 9, wherein the radiation source comprises an array of light-emitting diodes.

11. The system of claim 9, wherein the radiation source comprises a plurality of arrays of light-emitting diodes.

12. The system of claim 9, wherein the radiation source comprises a digital-minor device.

13. The system of claim 9, wherein the radiation source emits the radiation with a resolution of about 50 micrometers/dot or less.

14. The system of claim 9, wherein the radiation-curable material is soluble in a solvent in an uncured state and is substantially insoluble in the solvent in a cured state.

15. A method for building a three-dimensional object based on build data representing the three-dimensional object, wherein the build data includes a plurality of generated sliced layer, the method comprising:
(a) extruding a radiation-curable material to form a deposited layer;
(b) cooling the extruded radiation-curable material to a self-supporting state;
(c) selectively exposing a portion of the deposited layer to radiation in accordance with a first of the generated sliced layers, thereby forming a cured portion and an uncured portion of the deposited layer;
(d) repeating steps (a)-(c) for the remainder of the generated sliced layers.

16. The method of claim 15, further comprising removing the uncured portions of the deposited layers.

17. The method of claim 16, wherein removing the uncured portions of the deposited layers comprises dissolving the uncured portions.

18. The method of claim 16, wherein removing the uncured portions of the deposited layers comprises melting the uncured portions at a temperature that is lower than a melting temperature of the cured portion.

19. The method of claim 15, further comprising heating the radiation-curable material to a flowable state for extrusion.

20. The method of claim 15, wherein selectively exposing the portion of the deposited layer to radiation comprises selectively activating at least one of a plurality of light-emitting diodes oriented in a linear array.
